(19) United States
(12) Patent Application Publication
(10) Pub. No.: US 2013/0168370 A1
(43) Pub. Date: Jul. 4, 2013

(54) LASER-BEAM DEVICE, LASER-SOLDERING TOOL AND METHOD, FOR LASER-SOLDERING CONNECTION PADS OF A HEAD-STACK ASSEMBLY FOR A HARD-DISK DRIVE

(71) Applicant: Iraj Kavosh, San Jose, CA (US)

(72) Inventor: Iraj Kavosh, San Jose, CA (US)

(21) Appl. No.: 13/338,989

(22) Filed: Dec. 28, 2011

(51) Int. Cl. B23K 26/20; B23K 26/04

(52) U.S. Cl. 219/121.62; 219/121.64

(57) ABSTRACT

A laser-beam device for laser-soldering connection pads of a head-stack assembly (HSA) for a hard-disk drive (HDD). The laser-beam device includes a laser configured to provide a first beam of light, a rectangular flat-top beam-shaping (RFTBS) optic, and a focusing lens. The RFTBS optic is configured to shape the first beam of light into a second beam having a rectangular shape, and a substantially flat-top intensity profile in a far-field region. The focusing lens is configured to transform the second beam into a third beam aligned with connection pads of the HSA. The third beam of light has a substantially flat-top intensity profile and a rectangular beam shape matched to cover the connection pads, and is configured to generate heat about uniformly to reflow solder of the connection pads. A laser-soldering tool and a method, for laser-soldering connection pads of the HSA are also provided.

### TECHNICAL FIELD

Embodiments of the present invention relate to a laser-beam device, and a laser-soldering tool and method utilizing the laser-beam device of the laser-soldering tool for laser-soldering connection pads of a head-stack assembly (HSA) for a hard-disk drive (HDD).

### BACKGROUND

Hard-disk drives (HDDs) have been widely used as data-storage devices of computers and have become indispensable data-storage devices for current computer systems. A HDD includes a magnetic-recording disk for storing data, a head-slider, and an actuator for moving the head-slider to a designated position in proximity with the recording surface of the magnetic-recording disk. The assembly of the actuator and the head-slider is called a “head-stack assembly,” or “HSA”. The actuator is driven by a voice coil motor (VCM) and pivots on a pivot shaft to move the head-slider in a nominally radial direction of the magnetic-recording disk in proximity with the recording surface of the spinning magnetic-recording disk. This enables the head-slider to access the magnetic-recording disk. The head-slider includes a slider on which a magnetic-recording head is affixed, which includes a write element and/or a read element.

The actuator includes an elastic suspension, to which the head-slider is bonded. Force due to pressure caused by air viscosity between an air-bearing surface (ABS) of the head-slider facing the magnetic-recording disk and the spinning magnetic-recording disk balances a load on the head-slider applied by the suspension toward the magnetic-recording disk, so that the head-slider flies in proximity with the recording surface of the magnetic-recording disk. The suspension includes a gimbal for holding the head-slider on the surface of the suspension facing the magnetic-recording disk, and a load-beam for holding the gimbal to face the recording surface of the magnetic-recording disk. The gimbal is elastic so that the slider can tilt in specific directions to compensate for flutter of the magnetic-recording disk, for example.

On the actuator, a wiring structure, which is called a “lead-suspension,” is formed for transmitting signals between an arm electronics (AE) module, including an amplifier circuit, and elements on the head-slider. The AE module is mounted in a flexible printed circuit (FPC) affixed near the pivot shaft of the actuator. One end of the lead-suspension is connected with connection pads to the head-slider. The other end of the lead-suspension is connected with connection pads to the FPC.

Engineers and scientists engaged in HDD manufacturing and development are interested in manufacturing methods for components of the HDD, such as, the HSA, that are cost effective to meet the rising demands of the marketplace for increased value at low price, with good performance, and high reliability.

### SUMMARY

Embodiments of the present invention include a laser-beam device for laser-soldering connection pads of a head-stack assembly (HSA) for a hard-disk drive (HDD). The laser-beam device includes a laser, a rectangular flat-top beam-shaping (RFTBS) optic, and a focusing lens. The laser is configured to provide a first beam of light. The RFTBS optic is configured to shape the first beam of light into a second beam of light having a rectangular shape, and a substantially flat-top intensity profile in a far-field region. The focusing lens is configured to transform the second beam of light into a third beam of light aligned with a plurality of connection pads of the HSA. The third beam of light has a substantially flat-top intensity profile and a rectangular beam shape matched to cover the plurality of connection pads. The third beam of light is also configured to generate heat about uniformly at the plurality of connection pads to reflow solder of the connection pads in a laser-soldering operation. Other embodiments of the present invention include a laser-soldering tool and a method, for laser-soldering connection pads of the HSA.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a plan view depicting a configuration of a hard-disk drive (HDD) that utilizes a head-stack assembly (HSA) that is laser-soldered in accordance with embodiments of the present invention.

FIG. 2 is a perspective view depicting a configuration of the HSA that is laser-soldered in accordance with embodiments of the present invention.

FIG. 3 is an exploded perspective view depicting a configuration of a head-gimbal assembly (HGA), which is a component part of the HSA that is laser-soldered in accordance with embodiments of the present invention.

FIG. 4 is a plan view depicting a configuration of a portion of the HSA that is laser-soldered in accordance with embodiments of the present invention.

FIGS. 5A and 5B are a perspective view, and a plan view, respectively, that schematically depict the connections between connector tabs and a circuit board in the HSA that is laser-soldered in accordance with embodiments of the present invention.

FIG. 6 is a drawing that schematically depicts a structure and usage of a laser-beam device, and a tail-spreader, as used in a laser-soldering operation to join the connector tabs and the circuit board, in accordance with an embodiment of the present invention.

FIG. 7 is a perspective view showing in detail the connector tabs and the circuit board of the HSA, shown in FIG. 6, that is laser-soldered in accordance with embodiments of the present invention.

FIG. 8 is a schematic drawing that details the configuration of component parts of the laser-beam device used to laser solder the HSA of FIG. 2, and features of beam-formation, such as beam shape and beam intensity profile, in accordance with embodiments of the present invention.

FIG. 9 is a drawing schematically depicting a configuration of a laser-soldering tool, which is a manufacturing apparatus for performing laser-soldering of the HSA of FIG. 2, in accordance with an embodiment of the present invention.

FIG. 10 is a drawing schematically depicting details of the configuration of one or more laser-beam devices of the laser-soldering tool of FIG. 9 in a laser-soldering operation of the HSA of FIG. 2, in accordance with embodiments of the present invention.

FIG. 11 is a flowchart of a method for laser-soldering connection pads of the HSA of FIG. 2 for a HDD, in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary. Reference numerals may refer to both single components and pluralities of similar components.

### Description of Embodiments of the Present Invention for a Laser-Beam Device Laser-Soldering Tool and Method, for Laser-Soldering Connection Pads of a Head-Stack Assembly (HSA) for a Hard-Disk Drive (HDD)

Embodiments of the present invention include a laser-beam device for laser-soldering connection pads of a head-stack assembly (HSA) for a hard-disk drive (HDD). The laser-beam device includes a laser, a rectangular flat-top beam-shaping (RFTBS) optic, and a focusing lens. The laser is configured to provide a first beam of light. The RFTBS optic is configured to shape the first beam of light into a second beam of light having a rectangular shape, and a substantially flat-top intensity profile in a far-field region. The focusing lens is configured to transform the second beam of light into a third beam of light aligned with a plurality of connection pads of the HSA. The third beam of light has a substantially flat-top intensity profile and a rectangular beam shape matched to cover the plurality of connection pads. The third beam of light is also configured to generate heat about uniformly at the plurality of connection pads to reflow solder of the connection pads in a laser-soldering operation. Other embodiments of the present invention include a laser-soldering tool and a method, for laser-soldering connection pads of the HSA.

Embodiments of the present invention provide securer interconnection between a connector tab of a head-gimbal assembly (HGA) and a circuit board by providing uniform heating of the solder connection pads, thus, avoiding the formation of cold-solder joints, and increasing the manufacturing yield of HSAs, because of the substantially flat-top intensity profile of the laser beam provided by the laser-beam device used to solder the connection pads together. Thus, since the method for laser-soldering connection pads of the HSA provides substantially uniform heating of the solder connection pads, reliability of the solder joints produced is greater compared with processes in which alight beam is used that may have a non-uniform intensity profile that may result in cold-solder joints. Furthermore, embodiments of the present invention allow for batch processing the soldering of all the solder joints on a single lead-suspension, thus, avoiding time-consuming soldering of individual solder joints, one at time, because the rectangular beam shape provided by the laser-beam device is matched to cover the plurality of connection pads. Thus, since the method for laser-soldering connection pads of the HSA is a batch process, manufacturing time is reduced, and the cost of manufacturing is also reduced compared with processes that solder individual solder joints, one at time. In addition, as compared to, for example, a xenon-light beam having a wavelength in the ultraviolet (UV) and/or short-wavelength visible range that is strongly absorbed by a supporting layer upon which the connection pads are disposed, embodiments of the present invention reduce adventitious damage to the supporting layer, because a wavelength of the light is selected to have negligible light absorption by the supporting layer. Thus, since the method for laser-soldering connection pads of the HSA avoids directly heating the supporting layer, the supporting layer is more resilient and unembrittled when compared with a supporting layer wherein the light is absorbed by the supporting layer, breaks chemical bonds in the supporting layer, carbonizes the supporting layer, and outgases plasticizing constituents from the supporting layer. Thus, embodiments of the present invention provide for a wider soldering-process window in terms of laser power and/or laser energy that is applied to the target connection pads.

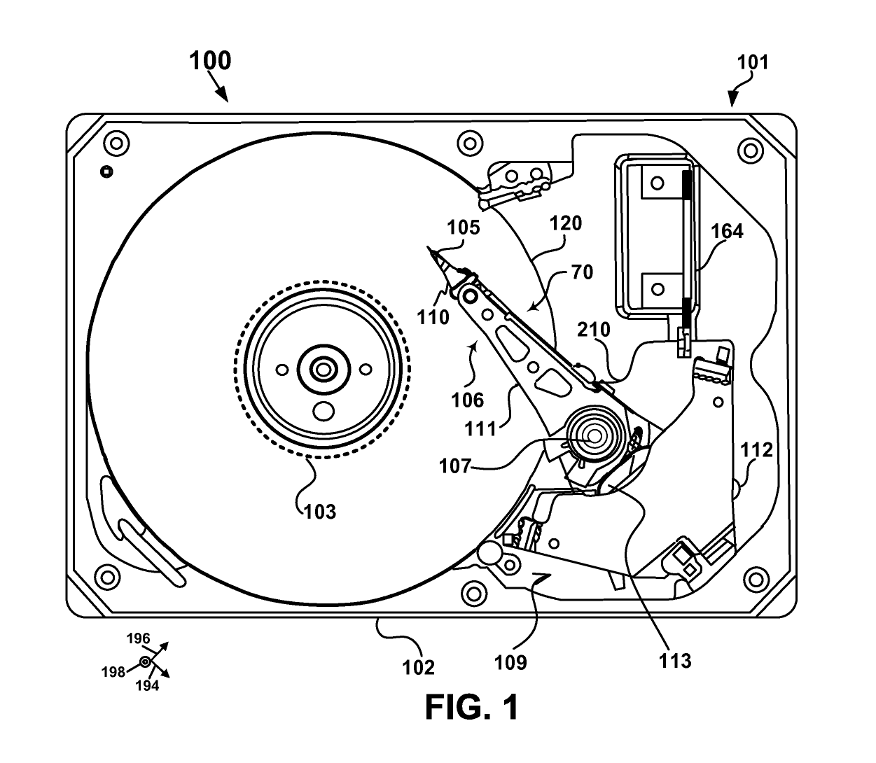

With reference now to FIG. 1, a plan view 100 is shown that depicts a configuration of a HDD 101 that utilizes a HSA 70 that is laser-soldered in accordance with embodiments of the present invention. As shown in FIG. 1, mechanical components for HDD 101 are housed in a base 102 of a disk enclosure. Operations of the components in the base 102 are controlled by a control circuit (not shown) on a circuit board affixed outside the base 102 of the disk enclosure. HDD 101 includes a magnetic-recording disk 120, which is a disk for storing data, and a head-slider 105 for accessing the magnetic-recording disk 120. As used herein, “access” is a term of art that refers to operations in seeking a data track of a magnetic-recording disk 120 and positioning a magnetic-recording head on the data track for both reading data from, and writing data to, a magnetic-recording disk 120. The head-slider 105 includes a magnetic-recording head for reading user data from and/or writing user data to the magnetic-recording disk 120, and a slider on which the magnetic-recording head is formed.

An actuator 106 holds the head-slider 105. The assembly of the actuator 106 and the head-slider 105 is referred to by the term of art, “head-stack assembly,” or “HSA” 70. In order to access the magnetic-recording disk 120, the actuator 106 pivots on a pivot shaft 107 to move the head-slider 105 in proximity with the recording surface of the spinning magnetic-recording disk 120. A voice coil motor (VCM) 109 drives the actuator 106 as a driving mechanism. The actuator 106 includes components of a HGA 110, an arm 111, a coil yoke 112, and a VCM coil 113 connected in the order recited from the distal end, where the head-slider 105 is disposed in a longitudinal direction of the actuator 106.

A spindle motor (SPM) 103 affixed to the base 102 spins the magnetic-recording disk 120 at a specific angular rate. A force due to pressure caused by air viscosity between an air bearing surface (ABS) of the head-slider 105 facing the magnetic-recording disk 120 and the spinning magnetic-recording disk 120 balances the load applied by the HGA 110 to the head-slider 105 in the direction toward the magnetic-recording disk 120 so that the head-slider 105 flies in proximity with the recording surface of the magnetic-recording disk 120.

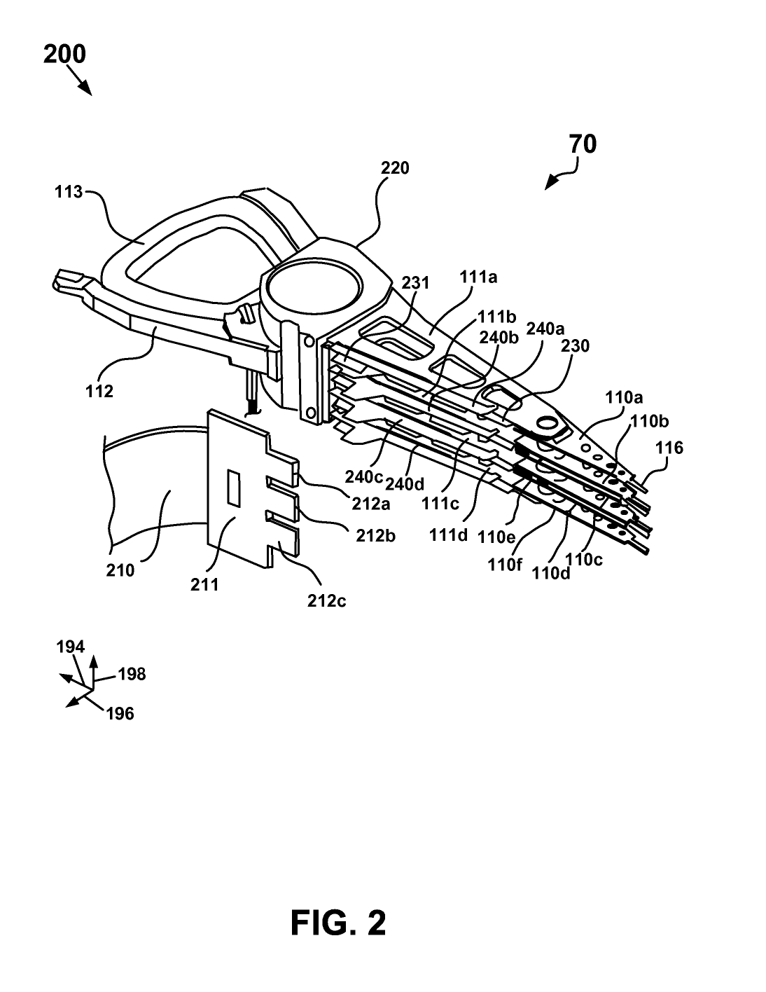

As shown in FIG. 1, the direction of arrow 196 is about perpendicular to the side of the HSA 70 facing the flexible printed circuit (FPC) 210 and the connector block 164 attached to an electrical feed-through situated in the base 102; the direction of arrow 194 is perpendicular to arrow 196 and is about parallel to the side of the HSA 70 facing the FPC 210; and, arrow 198, which is indicated by the arrow head of arrow 198, is about perpendicular to the plane of the base 102, as well as the plane of the recording surface of the magnetic recording disk 120, and therefore is perpendicular to arrows 194 and 196. Thus, the triad of arrows 194, 196 and 198 are related to one another by the right-hand rule for vectors in the direction of the arrows 194, 196 and 198 such that the cross product of the vector corresponding to arrow 194 and the vector corresponding to arrow 196 produces a vector parallel and oriented in the direction of the arrow 198. The triad of arrows 194, 196 and 198 is subsequently used to indicate the orientation of views for subsequently described drawings of various components of HDD 101, in particular drawings of HSA 70, which is next described with greater detail in the discussion of FIG. 2.

With reference now to FIG. 2, in accordance with an embodiment of the present invention, a perspective view 200 is shown that schematically depicts the structure of the HSA 70 that is laser-soldered in accordance with embodiments of the present invention. As shown in FIG. 2, the triad of arrows 194, 196 and 198 indicates the orientation in which HSA 70 is viewed in perspective view 200 relative to the plan view 100 of FIG. 1. As used herein, the direction along the actuator pivot shaft 107 is defined as an upward-and-downward direction; and, the direction toward the top cover of HDD 101 is defined as upward, and the direction toward the bottom of the base 102 of the DE is defined as downward. In the actuator 106, the direction toward the HGA 110 when viewed from the pivot shaft 107 is defined as frontward; and, the opposite direction is defined as rearward.

The HSA 70 exemplified in FIG. 2 includes a structure applicable to three magnetic-recording disks 120 that include recording surfaces on both sides of each magnetic-recording disk, for example, magnetic-recording disk 120. The actuator 106 includes four arms 111a-111d and six HGAs 110a-110f which are disposed so as to be stacked when viewed in the direction of the pivot axis. To the uppermost arm 111a and the lowermost arm and 111d, HGAs 110a and 110d are secured, respectively. To the respective surfaces of the middle arm 111b, the HGAs 110b and 110c are secured, and to the respective surfaces of the middle arm 111c, the HGAs 110d and 110e are secured. The plurality of arms 111a-111d is secured to the carriage 220 as a stack in HSA 70.

A wiring structure, which is referred to herein as a lead-suspension 230 extends rearward from the load beam 203. In FIG. 2, only the lead-suspension 230 of the HGA 110a is illustratively indicated by a reference numeral. The lead-suspension 230 includes a metal layer and conductive leads sandwiched between insulating layers on the metal layer. One end of the lead-suspension 230 is connected to connection pads of a head-slider 105 with head connection pads (not shown) of the lead-suspension 230. On the other end of the lead-suspension 230 that is closer to the pivot shaft 107, a connector tab 231, which is a projection extending in a lateral direction, which is a direction vertical to the pivot axis, of the actuator, is provided. The connector tab 231 includes a plurality of connection pads (not shown) on the connector tab 231 to be connected to FPC 210. On the plurality of arms 111a-111d, support portions 240a-240d are provided, respectively; each of the support portions 240a-240d houses and supports a corresponding lead-suspension 230 extending from the load-beam 203 of the HGA 110.

In the FPC 210, a plurality of conductive leads is arranged separated from each other, and integrated with an insulating sheet made of polyimide films. The FPC 210 is connected to the lead-suspension 230 to transmit signals between the head-slider 105 and a control circuit (not shown). An end of the FPC 210 is bonded to a base plate, which is secured to the actuator 106. The base plate and the FPC 210 constitute a circuit board 211. On the circuit board 211, an arm electronics (AE) module (not shown) including an amplifier circuit is mounted.

On the front end of the circuit board 211, a plurality of projections 212 are formed and slits are provided between the projections 212. On the surface of each projection 212, a plurality of connection pads is provided that will form solder joints for connecting the circuit board with the lead-suspension 230, upon laser soldering. With a connector tab 231 of a lead-suspension 230 inserted into a slit, the connection pads on the projection 212 and the connection pads formed on the connector tab 231 are interconnected by laser soldering.

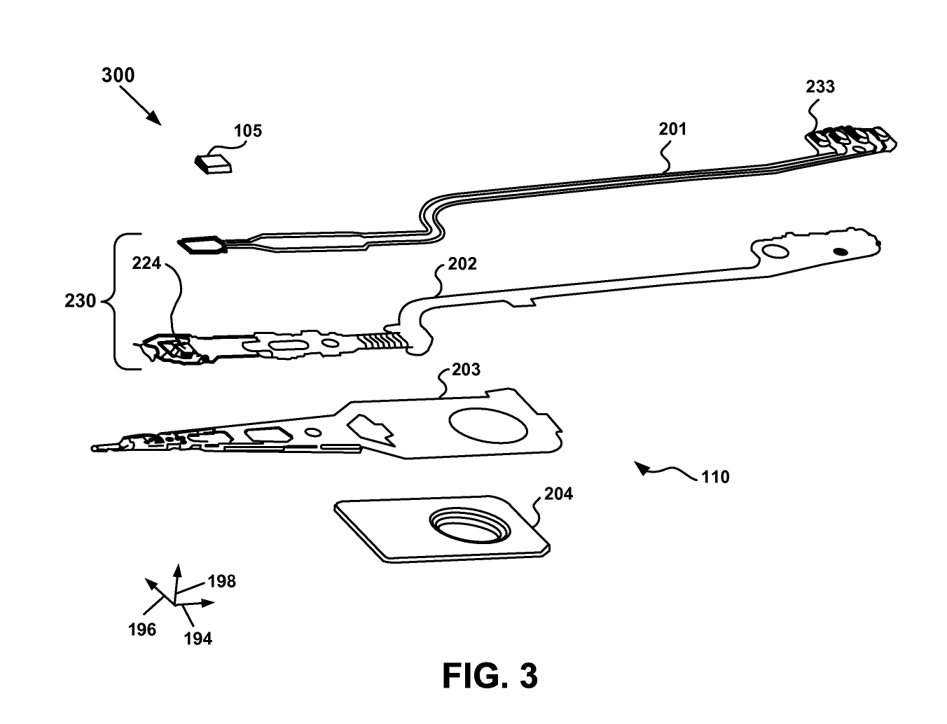

With reference now to FIG. 3, in accordance with an embodiment of the present invention, an exploded perspective view 300 is shown that shows components of HGA 110. As shown in FIG. 3, the triad of arrows 194, 196 and 198 indicates the orientation in which HGA 110 is viewed in perspective view 300 relative to the plan view 100 of FIG. 1. HGA 110 includes leads 201, a suspension 202 comprising a metal layer, a load-beam 203, a mounting plate 204, and the head-slider 105. A lead-suspension 230 includes the leads 201 and the suspension 202. In one embodiment of the present invention, the suspension 202 and the leads 201 of the lead-suspension 230 may be formed integrally to provide an integrated lead-suspension (ILS). The load-beam 203 is made of, for example, stainless steel in a form of a precision cantilever. The stiffness of the load-beam 203 is higher than that of the suspension 202. The load-beam 203 generates a load on the head-slider 105 because of the elastic properties of the load-beam 203.

The mounting plate 204 and the suspension 202 are made of, for example, stainless steel. The suspension 202 includes a gimbal 224 to which a head-slider 105 is affixed. The gimbal 224, which is supported elastically, holds the head-slider 105 and tilts freely to contribute to attitude control of the head-slider 105.

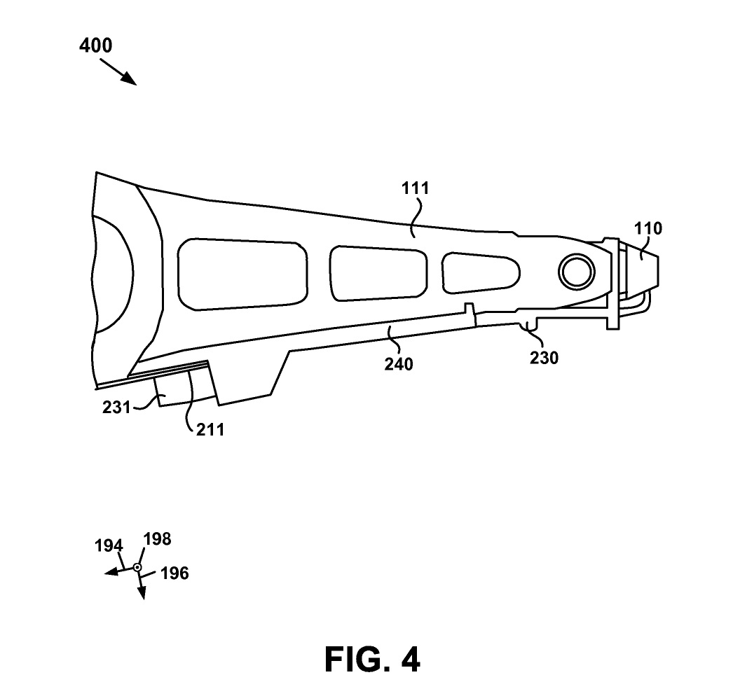

With reference now to FIG. 4, in accordance with an embodiment of the present invention, a plan view 400 is shown that schematically depicts a portion of the structure of an HSA 70 that is laser-soldered in accordance with embodiments of the present invention. As shown in FIG. 4, the triad of arrows 194, 196 and 198 indicates the orientation in which HSA 70 is viewed in plan view 400 relative to the plan view 100 of FIG. 1. As described above, the lead-suspension 230 includes the metal layer of the suspension 202 and the leads sandwiched between polyimide insulating layers provided on the metal layer. The lead-suspension 230 extends from the side of the HGA 110 opposite to the rotational axis of the magnetic-recording disk 120. The lead-suspension 230 extending rearward from the suspension 202 extends along the side of the arm 111, which is the side distal from the center of the magnetic-recording disk 120, toward the pivot shaft 107, which is rearward of the actuator 106.

At the rear end, which is the end close to the pivot shaft, also referred to by the term of art, “tail,” of the lead-suspension 230, a connector tab 231, which is a projection for connecting with the circuit board 211, is formed. The connector tab 231 has a large width, which is larger than that of the other portion in the tail extending rearward from the load-beam 203. Referring to FIG. 3, on the connector tab 231, a plurality of connection pads 233 are provided for laser-soldering to FPC 210; the connection pads 233 are connected with leads of the lead-suspension 230. The large width of the connector tab 231 provides effective connection with connection pads on the circuit board 211 of FPC 210.

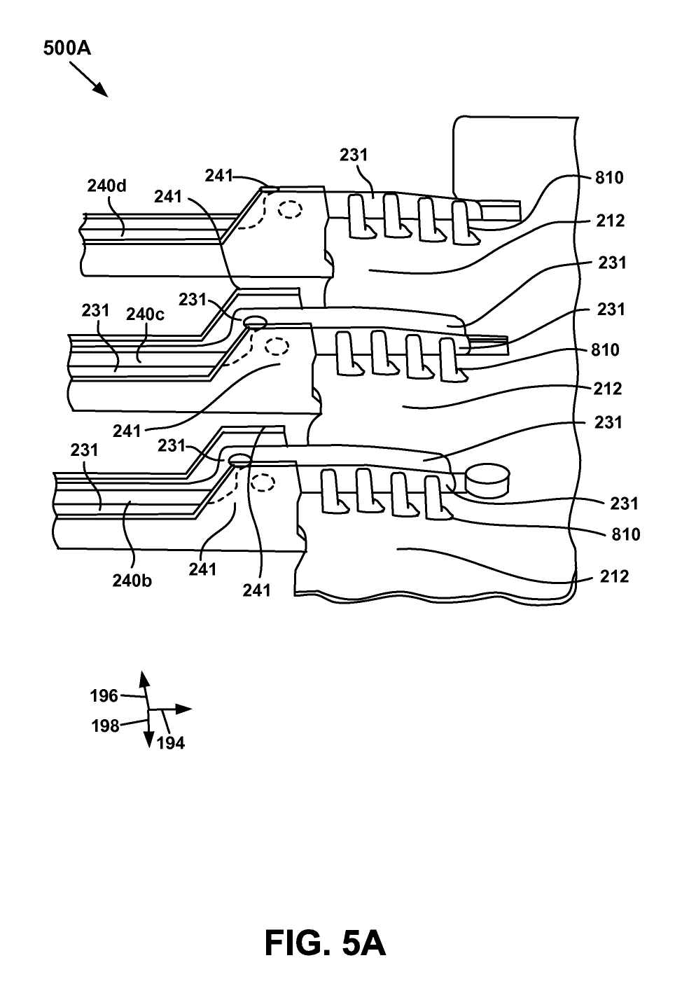

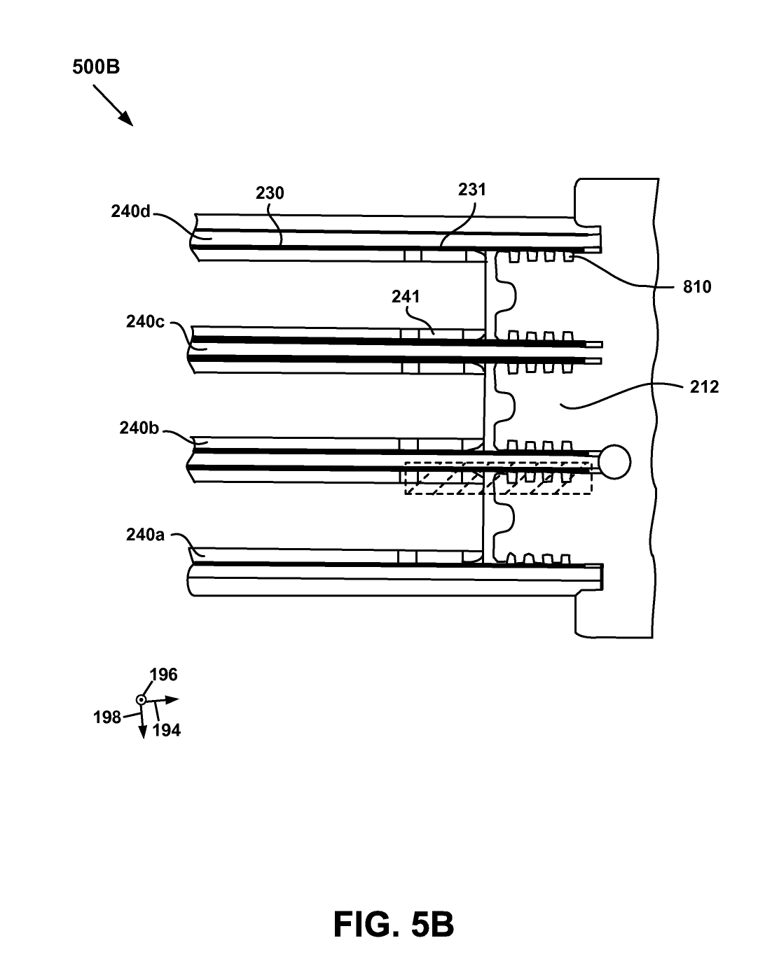

With reference now to FIGS. 5A and 5B, a perspective view 500A, and a plan view 500B, respectively, are shown that schematically depict the connections between connector tabs 231 of lead-suspensions, of which lead suspension 230 is an example, and projections 212 of the circuit board 211 of the HSA 70 that is laser-soldered in accordance with embodiments of the present invention. As shown in FIGS. 5A and 5B, the triad of arrows 194, 196 and 198 indicates the orientation in which HSA 70 is viewed in perspective view 500A, and plan view 500B, respectively, relative to the plan view 100 of FIG. 1. Connection pads formed on the end portion of a projection 212 and the connection pads formed on the surface facing the projection 212 of a connector tab 231 are connected by solder to form solder joints 810. In each slit between projections 212, connector tabs 231 of two lead-suspensions supported by a single support member 240 are inserted and disposed. Connection pads formed on the surface facing a projection 212 of each connector tab 231 and connection pads provided on the corresponding end portion of the projection 212 are interconnected by solder. Solder and flux may be provided in tinning and fluxing operations of corresponding lead-suspensions, of which lead suspension 230 is an example, and the connection pads of projections 212 to provide the connection pads with solder and flux prior to assembly and the laser-soldering operation.

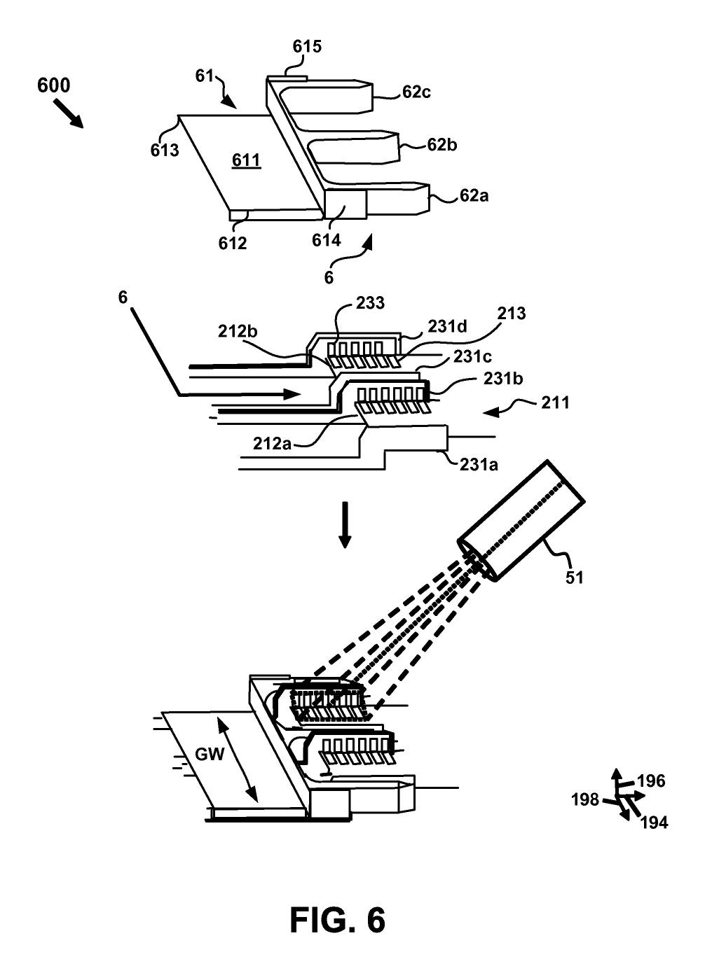

By way of example without limitation thereto, as shown in FIGS. 5A and 5B, four connection pads of a connector tab 231 of a lead-suspension 230 and four connection pads of a projection 212 of the circuit board 211 are soldered in the laser-soldering operation. In the laser-soldering operation, in accordance with embodiments of the present invention, a beam of light provided by laser-beam device 51 (see FIGS. 6 and 8-10) is applied simultaneously to eight connection pads to solder the connection pads together. By way of example without limitation thereto, eight connection pads may be covered by a beam of light having a substantially rectangular beam shape in alignment with the connection pads. In other embodiments of the present invention, in the laser-soldering operation, by way of example, a laser beam provided by a laser such as, for example, a solid state laser, a neodymium doped yttrium aluminum garnet (Nd:YAG) laser, or a near infra-red fiber laser, may be used with a wavelength in the near infra-red band of wavelengths to avoid damaging portions of components, such as the lead-suspension 230 and the circuit board 211, composed of polyimide, or other organic constituents. A method of interconnecting connection pads of a connector tab 231 of a lead-suspension 230 and connection pads of the circuit board 211 is next described.

With reference now to FIG. 6, in accordance with an embodiment of the present invention, a drawing 600 is shown that schematically depicts a structure and a usage of the laser-beam device 51, and a tail-spreader 6, as used in a method for laser-soldering connection pads 233 on the connector tabs 231 of the lead suspensions, of which lead suspension 230 (see FIGS. 3 and 4) is an example, and connection pads 213 of the circuit board 211 of FPC 210. By way of example and for ease of description without limitation thereto, FIG. 6 exemplifies a method for laser-soldering connection pads 233 and 231 of an HSA, like HSA 70, but only having three arms and four HGAs, as implemented for FIG. 6. The connector tab 231a is the connector tab of the HGA secured at the uppermost layer. The connector tabs 231b, 231c, and 231d are connector tabs of the HGAs at the second layer, the third layer, and the lowermost layer, respectively. The connector tabs 231b and 231c are the connector tabs of the HGAs that are secured to the same arm in the middle. As shown in FIG. 6, the triad of arrows 194, 196 and 198 indicates the orientation in which a HSA, like HSA 70, would be viewed in drawing 600 relative to the plan view 100 of FIG. 1.

With further reference to FIG. 6, in accordance with an embodiment of the present invention, in interconnecting connection pads 233 of a connector tab 231 of a lead suspension, for example, lead-suspension 230, and connection pads 213 of the circuit board 211, a tool, referred to by the term of art, “tail spreader” 6, is used to press the connector tab 231 against the circuit board 211 to provide secure interconnection between the connection pads 233 and 213. As shown at the top of FIG. 6, the tail-spreader 6 includes a guide 61 and projections 62a-62c at the rear of the guide 61. As shown in the middle of FIG. 6, the method of the laser-soldering operation for interconnecting the connection pads 233 and 213 of the connector tab 231 and the circuit board 211, respectively, slides the tail-spreader 6 along the lead-suspension 230 so that the projections 62a-62c are pressed against the connector tabs 231a-231d. Alternatively, by way of example without limitation thereto, the tail portion, itself, of a lead-suspension 230 that has an ILS design may also be used to press against the circuit card 211 on which the connection pads 213 are disposed. The projections 62a-62c press the connector tabs 231a-231d against the circuit board 211.

Subsequently, as shown at the bottom of FIG. 6, while keeping the connector tabs 231a-231d pressed against the circuit board 211 with the tail-spreader 6, the method for laser-soldering connection pads, for example, connection pads 233 and 213, of the HSA 70 applies a laser beam to the interconnection portions between the connector tabs 231a-231d and the circuit board 211. By way of example, in one embodiment of the present invention, the connection pads 233 of the connector tabs 231a-231d and the connection pads 213 of the circuit board 211 may be pretinned with solder, and pre-coated with solder flux, without limitation thereto. The solder is reflowed by heat from a beam of light provided by the laser-beam device 51 to interconnect the connection pads 233 and 213. Alternatively, solder paste may be used instead of pretinning the connection pads with a solder coating.

After completion of the laser-soldering operation, the method for laser-soldering connection pads 233 and 213 of the HSA 70 includes removing the tail-spreader 6 from the HSA 70. The use of the tail-spreader 6 provides interconnection between the connection pads 233 of the connector tabs 231a-231d and the connection pads 213 of the circuit board 211 during the laser-soldering operation. Laser soldering with connector tabs 231a-231b pressed against the circuit board 211 by the projections 62a-62c provides securer interconnection between the connection pads 233 and 213.

As shown in FIG. 6, the circuit board 211 includes two projections 212a and 212b and a slit. As explained with reference to FIGS. 5A and 5B, the projections 212a and 212b extend along the side of an arm 111 (see FIG. 4) toward the front of the actuator. The projections 212a and 212b are arranged in the direction parallel to the actuator pivot shaft 107 (see FIG. 1). On the respective upper sides and the lower sides of the projections 212a and 212b, connection pads are provided in a fore-and-aft direction. In the example shown in FIG. 6, six connection pads 213 c are arranged along a line extending in the front- and rear direction; and, this line is associated with a single connector tab, for example, one of connector tabs 231b and 231d as shown in the middle and bottom of FIG. 6.

As shown in the middle of FIG. 6, the connector tabs 231a-231d of the lead-suspensions extending from the front toward the rear of the arms 111 (see FIGS. 2 and 4) are arranged so as to overlap with the circuit board 211 when viewed in an upward-and-downward direction. Specifically, the connector tab 231a is placed higher than the projection 212a and the connector tabs 231b and 231c are placed within the slit. The connector tab 231d is placed lower than the projection 212b. The connector tabs 231a and 231b sandwich the projection 212a, and the connector tabs 231c and 231d sandwich the projection 212b.

As to the connector tabs 231a-231d, the main faces, which are the broadest faces, on which their connection pads 233 are provided are placed so as to face the edges of the projections 212a and 212b of the circuit board 211. In other words, the main faces, which are the broadest faces, of the projections 212a and 212b on which their connection pads 213 are provided are placed so as to intersect with the main faces, which are the broadest faces, of the connector tabs 231a-231d at predetermined angles, which are typically at right angles. On the connector tabs 231a-231d, connection pads are arranged along a line extending in a fore-and-aft direction. Such an arrangement of the connector tabs 231a-231d and the projections 212a and 212b allows the connection pads 233 of the connector tabs 231a-231d to face the connection pads 213 of the projections 212a and 212b at predetermined angles, which are typically right angles.

The connection pads 233 are formed on the main faces of the connector tabs 231a-231d facing the projections 212a and 212b. Specifically, the pad forming face of the connector tab 231a is in contact with the upper edge of the projection 212a. The pad forming face of the connector tab 231b is in contact with the lower edge of the projection 212a. The pad forming face of the connector tab 231c is in contact with the upper edge of the projection 212b, and the pad forming face of the connector tab 231d is in contact with the upper edge of the projection 212b.

The tail-spreader 6 presses the connector tabs 231a-231d against the projections 212a and 212b having the above-described positional relationship between the projections 212a and 212b. As shown at the bottom of FIG. 6, the uppermost projection 62a presses the connector tab 231a against the projection 212a. The middle projection 62b presses the connector tabs 231b and 231c against the projections 212a and 212b, respectively. The lowermost projection 62c presses the connector tab 231d against the projection 212b. The projections 62a-62c make contact with and press the back faces of the pad forming faces of the connector tabs 231a-231d.

The guide 61 of the tail-spreader 6 contacts with the arm 111 (see FIG. 4) of a HSA, like HSA 70. By way of example without limitation thereto, the guide 61 may include a main plate 611 and side plates 612 and 613 which are perpendicular to the main plane. In the width direction of the main plate 611, the projections 62a-62c are provided. When the tail-spreader 6 is attached to a HSA, like HSA 70, the width GW of the main plate 611 corresponding to the height of the guide 61. The width GW of the main plate 611 has the same dimension as the distance from the top surface of the uppermost arm to the under surface of the lowermost arm of a HSA, like HSA 70.

In attachment of the tail-spreader 6, the back surface of the main plate 611 contacts the edges of the arms, and the side plates 612 and 613 contact the uppermost arm and the lowermost arm, respectively, to guide the sliding direction of the tail-spreader 6. Thus, the guide 61 provided for the tail-spreader 6 allows easy setting of the tail-spreader 6 at a predetermined position during the laser-soldering operation in manufacture of a HSA, like HSA 70.

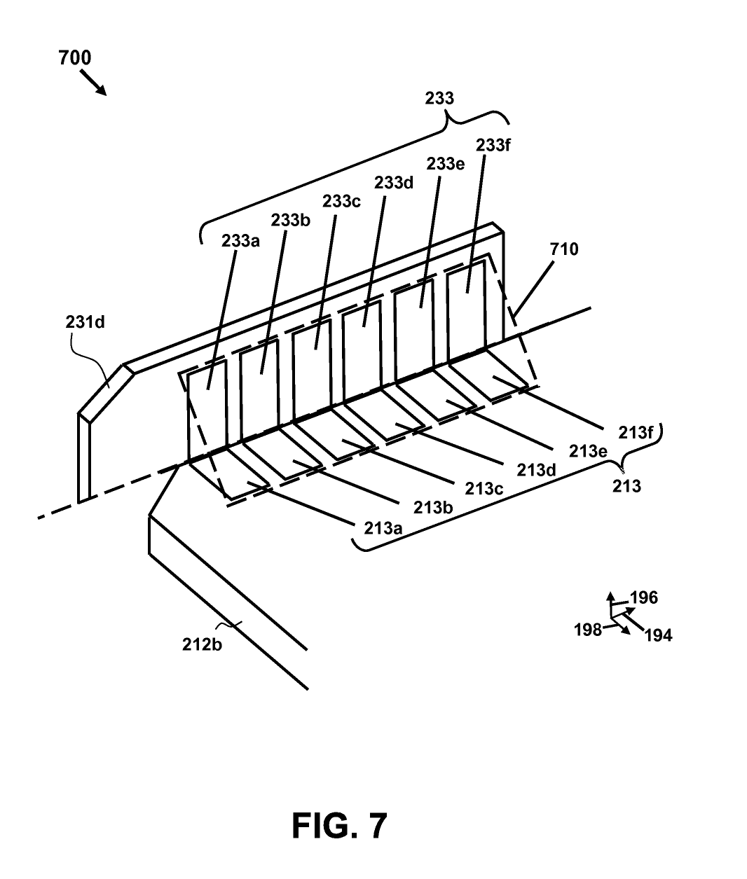

With reference now to FIG. 7, in accordance with an embodiment of the present invention, a perspective view 700 shows details of the connector tab 231d and the projection 212b of the circuit board 211 of the HSA, shown in FIG. 6 that is laser-soldered in accordance with embodiments of the present invention. As shown in FIG. 7, the triad of arrows 194, 196 and 198 indicates the orientation in which a HSA, like HSA 70, would be viewed in perspective view 700 relative to the plan view 100 of FIG. 1. FIG. 7 shows connection pads 233 on a connector tab 231d of a lead-suspension, for example, lead suspension 230, and connection pads 213 on a projection 212b of a circuit board 211 of FPC 210. Connection pads 233 include individual connection pads 233a-233f. Connection pads 213 include individual connection pads 213a-213f. In the laser-soldering operation, solder joints 810 (see FIG. 4) are formed between respective connection pads in pairs, for example, connection pad 233a with connection pad 213a. The solder joints 810 (see FIG. 4) provide electrical continuity for the transmission of signals, for example, from FPC 210 to lead-suspension 230 and then to the magnetic-recording head of head-slider 105. Thus, in the laser-soldering operation, in one embodiment of the present invention, a plurality of connection pads 233 on a connector tab 231 of a lead-suspension 230 are soldered to a plurality of connection pads 213 on a projection 212 of a circuit board 211 of a FPC 210. Moreover, in an alternative embodiment of the present invention, a plurality of head connection pads (not shown) of a lead-suspension 230 may also be soldered to a plurality of connection pads on a head-slider 105. Thus, in accordance with embodiments of the present invention, the connection pads may be selected from the group consisting of the following pairs: connection pads (not shown) of a head-slider 105 and head connection pads (not shown) of a lead-suspension 230, and connection pads 233 on a connector tab 231 of a lead-suspension 230 and connection pads 213 on a projection 212 of a circuit board 211 of a FPC 210, as shown in FIG. 7. Also shown in FIG. 7 is an outline 710 of the beam of light, which is aligned to solder connection pads 233 to connection pads 213, of the laser-beam device 51, which is next described in greater detail.

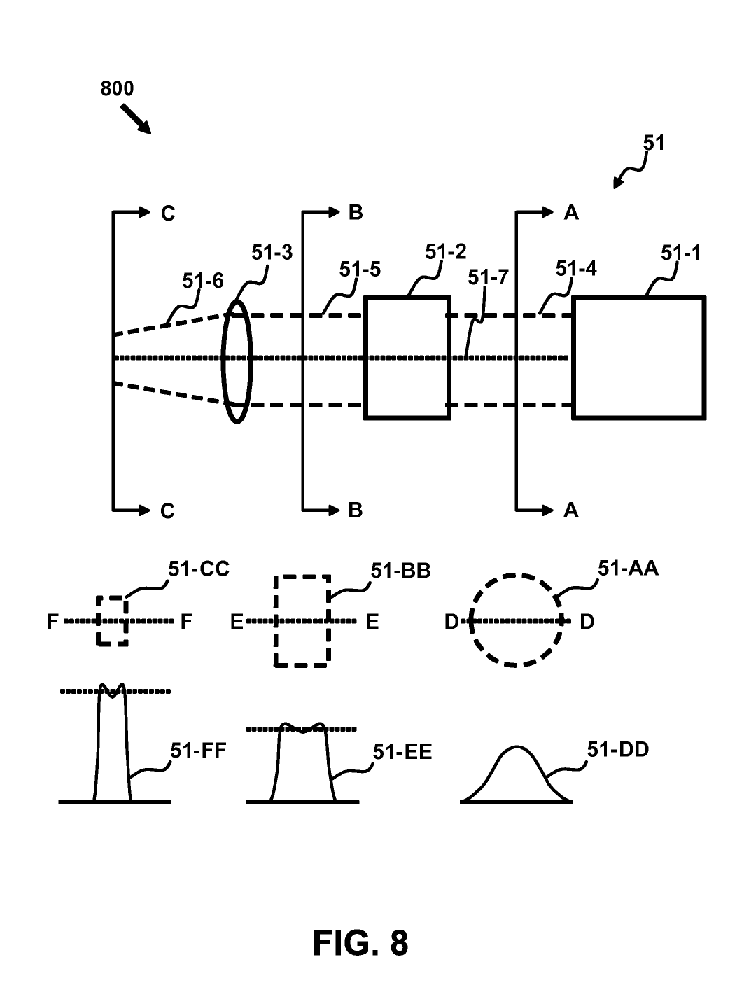

With reference now to FIG. 8, in accordance with embodiments of the present invention, a schematic drawing 800 is shown of a laser-beam device 51 for laser-soldering connection pads of HSA 70 for HDD 101. FIG. 8 details the configuration of component parts of the laser-beam device 51 used to laser solder the HSA 70 of FIG. 2. The laser-beam device 51 includes a laser 51-1, a rectangular flat-top beam-shaping (RFTBS) optic 51-2, and a focusing lens 51-3. The laser 51-1 is configured to provide a first beam of light 51-4. By way of example without limitation thereto, the laser 51-1 may include any of the following: a continuous-wave laser, a solid-state laser, a pulsable laser, and lasers that are combinations of the preceding types of lasers. By way of example, the laser 51-1 may have a power of about 20 watts (W), without limitation thereto. The laser-beam device 51 may also include a fiber-optical element coupling the laser 51-1 to the RFTBS optic 51-2, and configured to transmit the first beam of light 51-4 from an exit pupil of the laser 51-1 to an entrance pupil of the RFTBS optic 51-2, which is next described in greater detail.

With further reference to FIG. 8, in accordance with embodiments of the present invention, the RFTBS optic 51-2 is configured to shape the first beam of light 51-4 into a second beam of light 51-5 having a rectangular shape 51-BB, and a substantially flat-top intensity profile 51-EE in a far-field region. By way of example without limitation thereto, in one embodiment of the present invention, RFTBS optic 51-2 may include a rectangular flat-top beam shaper similar to that described in U.S. Pat. No. 7,400,457, entitled “RECTANGULAR FLAT-TOP BEAM SHAPER,” of inventor Francis Cayer, at issuance assigned to Stockyale Canada Inc., subsequently assigned to Coherent, Inc. In accordance with other embodiments of the present invention, the RFTBS optic 51-2 may also include a diffractive optical element (DOE), without limitation thereto.

With further reference to FIG. 8, in accordance with embodiments of the present invention, the focusing lens 51-3 is configured to transform the second beam of light 51-5 into a third beam of light 51-6 that may be aligned with a plurality of connection pads, for example, connection pads 233 and 213 (see FIG. 7), of HSA 70, for laser-soldering the connection pads to form a plurality of solder joints 810 (see FIG. 4). Moreover, the focusing lens 51-3 may be configured to focus the second beam of light 51-5 into a third beam of light 51-6 having a rectangular shape 51-CC, as indicated by the outline 710 shown in FIG. 7, aligned with the plurality of connection pads, for example, connection pads 233 and 213 (see FIG. 7), of HSA 70, for laser-soldering the connection pads to form a plurality of solder joints 810 (see FIG. 4). The wavelength of the light, including light of the third beam of light 51-6, is selected to have negligible light absorption by a supporting layer on which the plurality of connection pads, for example, connection pads 233 and 213, is disposed. Thus, the wavelength of the light is selected to lie in a transmission band of material composing the supporting layer, which by way of example may be polyimide, without limitation thereto. In one embodiment of the present invention, the wavelength of the light may lie in a band extending from about green into and through near infra-red wavelengths. For example, the wavelength of the light may lie in a band from about 1064 nanometers (nm) to about 1089 nm.

With further reference to FIG. 8, in accordance with embodiments of the present invention, the schematic drawing 800 also shows features of the beam-formation system of the laser-beam device 51, such as beam shapes and beam intensity profiles, of beams of light at various locations in the optical path of the laser-beam device 51. To show these features, cross-sections are taken at planes perpendicular to the optical axis 51-7 of the laser-beam device 51 indicated by the traces of the planes shown as lines A-A, B-B and C-C. Thus, the first beam of light 51-4 has about a circular shape 51-AA at the cross-section corresponding to line A-A. The second beam of light 51-5 has about a rectangular shape 51-BB at the cross-section corresponding to line B-B. The third beam of light 51-6 also has about a rectangular shape 51-CC at the cross-section corresponding to line C-C. Moreover, the focusing lens 51-3 may be configured to demagnify the second beam of light 51-5 into a third beam of light 51-6 having rectangular shape 51-CC smaller than rectangular shape 51-BB, but with the same aspect ratio as rectangular shape 51-BB. The aspect ratio of the rectangular shapes 51-BB and 51-CC may be chosen to cover the connection pads, for example, connection pads 233 and 213, as indicated by the outline 710 of the third beam of light 51-6, described above in the discussion of FIG. 7.

With further reference to FIG. 8, in accordance with embodiments of the present invention, the lines D-D, E-E and F-F indicate the location where beam intensity profiles can be measured of the beam cross-sections corresponding to the traces of the planes shown as lines A-A, B-B and C-C, respectively. Thus, by way of example without limitation thereto, the first beam of light 51-4 may have an intensity profile 51-DD corresponding to line D-D, which is about Gaussian, or bell-shaped. Alternatively, the intensity profile 51-DD may be other than Gaussian. The second beam of light 51-5 has an intensity profile 51-EE corresponding to line E-E, which is about flat-topped. The intensity of the second beam of light 51-5 in a flat-top portion of the flat-top intensity profile 51-EE varies by no more than plus or minus ten percent from an average intensity of the second beam of light 51-5 in the flat-top portion of the flat-top intensity profile 51-EE. As shown in FIG. 8, the average intensity of the second beam of light 51-5 in the flat-top portion of the flat-top intensity profile 51-EE is indicated by the horizontal line at the top of flat-top intensity profile 51-EE, The third beam of light 51-6 has an intensity profile 51-FF corresponding to line F-F, which is also about flat-topped. Similarly, the intensity of the third beam of light 51-6 in a flat-top portion of the flat-top intensity profile 51-FF varies by no more than plus or minus ten percent from an average intensity of the third beam of light 51-6 in the flat-top portion of the flat-top intensity profile 51-FF. As shown in FIG. 8, the average intensity of the third beam of light 51-6 in the flat-top portion of the flat-top intensity profile 51-FF is indicated by the horizontal line at the top of flat-top intensity profile 51-FF,

With further reference to FIG. 8, in accordance with embodiments of the present invention, the laser-beam device 51 may further include a beam stop (not shown) having an aperture dimensioned such that the beam stop is configured to cut off the second beam of light 51-5 starting from a position proximate to a roll-off portion of the flat-top intensity profile 51-EE and extending away from a flat-top portion of the flat-top intensity profile 51-EE. The aperture may have a rectangular shape. Thus, the sides of the aperture may be about parallel to sides of a cross-section through the second beam of light 51-5 within a plane about normal to a central ray of the second beam of light 51-5, which lies on the optical axis 51-7 of the laser-beam device 51.

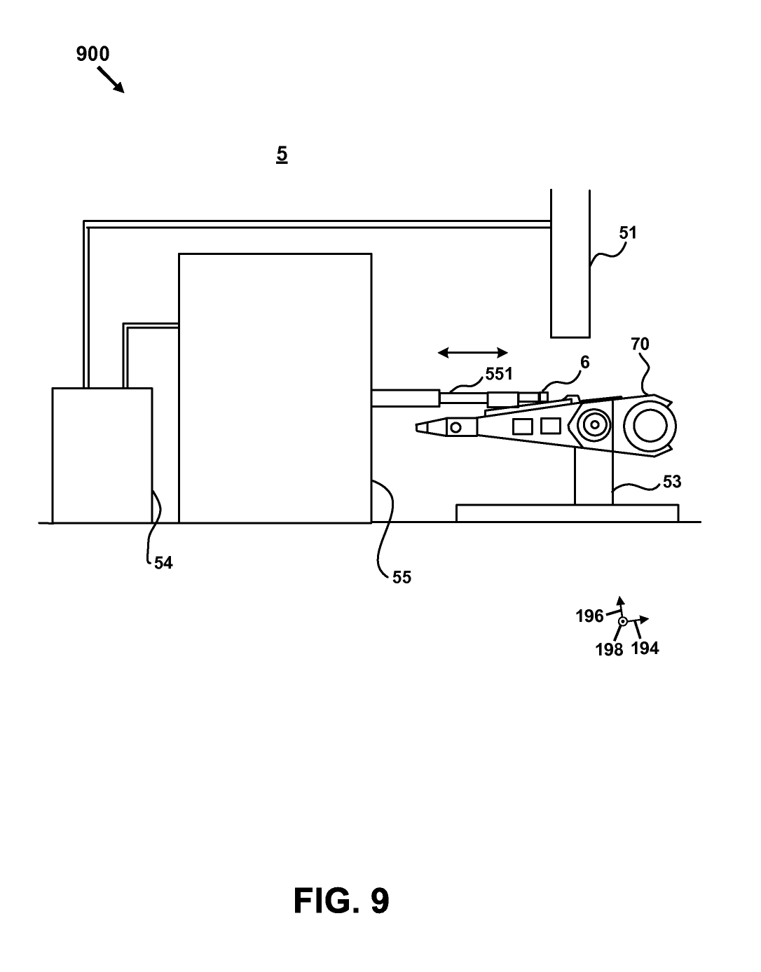

With further reference to FIG. 8, in accordance with embodiments of the present invention, the third beam of light 51-6 may be aligned with a plurality of connection pads, for example, connection pads 233 and 213 (see FIG. 7), of HSA 70. The third beam of light 51-6 has a substantially flat-top intensity profile 51-FF and a rectangular beam shape 51-CC matched to cover the plurality of connection pads, for example, as shown in FIG. 7 by outline 710. The third beam of light 51-6 is configured to generate heat about uniformly at the plurality of connection pads, for example, connection pads 233 and 213 (see FIG. 7), to reflow solder of the connection pads in the laser-soldering operation. Thus, in accordance with embodiments of the present invention, the third beam of light 51-6 may be aligned with the plurality of connection pads, for example, connection pads 233 and 213 (see FIG. 7), of HSA 70, and is configured to uniformly heat the plurality of connection pads, for the laser-beam device 51 installed in the laser-soldering tool 5 (see FIG. 9), which is next described.

With reference now to FIG. 9, in accordance with an embodiments of the present invention, a drawing 900 is shown that schematically depicts a configuration of the laser-soldering tool 5, which is a manufacturing apparatus to perform laser soldering of the HSA 70. As shown in FIG. 9, the triad of arrows 194, 196 and 198 indicates the orientation in which a HSA, like HSA 70, would be viewed in drawing 900 relative to the plan view 100 of FIG. 1. The laser-soldering tool 5 includes a laser-beam device 51, a tail-spreader handler 55 for operating the tail-spreader 6, a support platform 53 for supporting HSA 70, and a controller 54 for controlling operation of the laser-soldering tool 5. In the laser-soldering operation, HSA 70 is set upon, and affixed to, the support platform 53.

With further reference to FIG. 9, in accordance with embodiments of the present invention, the tail-spreader handler 55 includes an arm 551; and, at an end of the arm, the tail-spreader 6 is secured. The arm 551 is extendable in the fore-and-aft direction; the arm 551 extends to insert the tail-spreader 6 into HSA 70 for laser soldering connection pads 233 and 231 of the connector tabs 231 and the circuit board 211, respectively. After the completion of the laser-soldering operation, the arm 551 retracts to remove the tail-spreader 6 from HSA 70. The tail-spreader handler 55 controlled by the controller 54 slides the tail-spreader 6 toward HSA 70 using the arm 551. As explained with reference to FIG. 6, the guide 61 of the tail-spreader 6 slides in contact with the side of the arm of HSA 70 to insert the projections 62a-62c into HSA 70. Specifically, the projections 62a-62c are slid so as to be located between the middle connector tabs, and outside the uppermost and the lowermost connector tabs.

With further reference to FIG. 9, in accordance with embodiments of the present invention, when the tail-spreader 6, and the arm 551 stops, and is set to an appropriate position in HSA 70, the controller 54 controls the laser-beam device 51 to begin irradiation of the connection pads 233 and 213 of the connector tabs 231 and the circuit board 211, respectively, with the third beam of light 51-6. The heat generated by the third beam of light 51-6 reflows the solder to interconnect the connection pads 233 and 213 without direct contact. After a predetermined time has passed, the controller 54 stops the laser-beam irradiation by the laser-beam device 51, and waits for another predetermined time. Thus, in accordance with an embodiment of the present invention, the molten solder hardens to interconnect the connection pads 233 and 213 of the connector tabs 231 and the circuit board 211, respectively, by laser soldering. The controller 54 controls the tail-spreader handler 55 to remove the tail-spreader 6 from HSA 70 after a predetermined time period. Specifically, the tail-spreader handler 55 retracts the arm 551 to slide the tail-spreader 6 in the direction away from HSA 70 for removing the tail-spreader 6 from HSA 70. On the support platform 53, another HSA may be set; and, the laser-soldering operation may be repeated on another HSA.

A laser-soldered HSA 70 is removed from the support platform 53, and sent to an assembly operation of HDD 101. The assembly operation of HDD 101 mounts an SPM 103 and magnetic-recording disks 120 on a base 102, and then affixes HSA 70 within the base. The assembly operation of HDD 101 mounts components, such as: a VCM 109, a ramp, connectors for a control circuit board, and other HDD components; and, the assembly operation of HDD 101 then secures a top cover to the top of the base 102 of the disk enclosure. Thus, the assembly operation of a head-disk assembly (HDA) is completed. Then, the HDA is subjected to a servo write operation and a test operation; and, assembly of HDD 101 with the HDA including a control circuit board is completed.

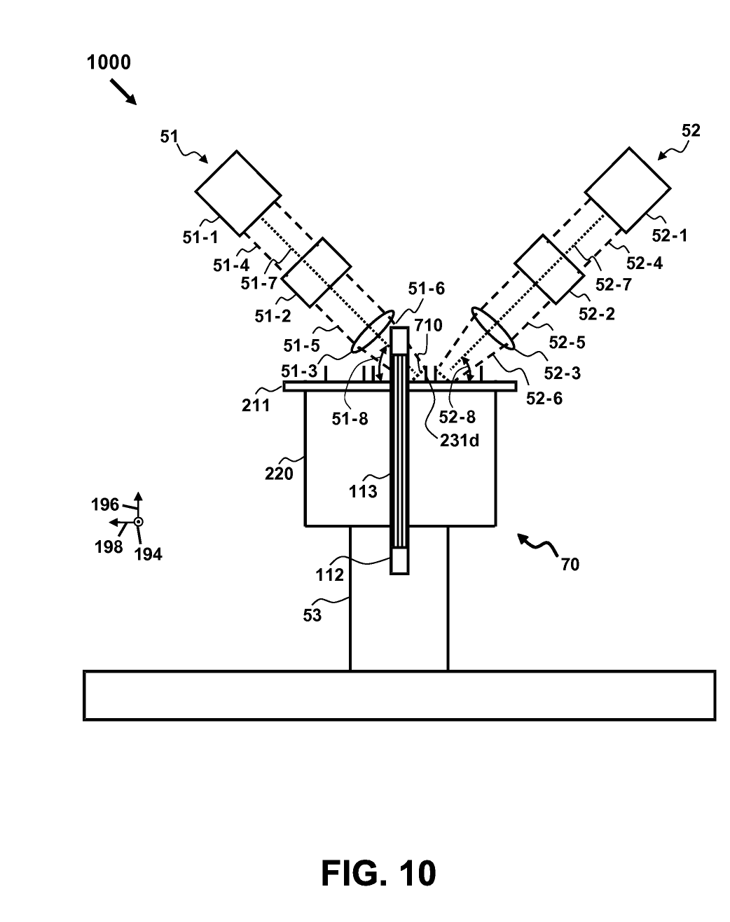

With reference now to FIG. 10, and further reference to FIGS. 7-9, in accordance with embodiments of the present invention, a drawing 1000 is shown that schematically depicts details of the configuration of one or more laser-beam devices, for example, laser-beam devices 51 and 52, of the laser-soldering tool 5 of FIG. 9 in a laser-soldering operation of the HSA 70 of FIG. 2. As shown in FIG. 10, the triad of arrows 194, 196 and 198 indicates the orientation in which HSA 70 is viewed in drawing 1000 relative to the plan view 100 of FIG. 1. The laser-soldering tool 5 includes a support platform 53 and at least one laser-beam device 51. The support platform 53 is configured to support the HSA 70. As shown in FIG. 10, HSA 70 is shown with the back of HSA 70 facing the viewer; thus, the carriage 220 is shown mounted on a column of the support platform 53 with the voice coil 113 mounted vertically in the coil yoke 112 facing towards the viewer, and with the circuit board 211 of the FPC 210 mounted on the side of HSA 70 facing the laser-beam devices 51 and 52.

With further reference to FIGS. 7-10, in accordance with embodiments of the present invention, at least one laser-beam device 51 includes a laser 51-1, a RFTBS optic 51-2, and a focusing lens 51-3, as previously described in the discussion of FIG. 8. Thus, although all embodiments of the present invention for the laser-beam device 51 may not be expressly described in the discussion of FIG. 10, it is understood that embodiments of the present invention for the laser-beam device 51 discussed herein may be incorporated within the environment of the laser-soldering tool 5. Thus, the laser 51-1 is configured to provide a first beam of light 51-4. The RFTBS optic 51-2 is configured to shape the first beam of light 51-4 into a second beam of light 51-5 having a rectangular shape 51-BB, and a substantially flat-top intensity profile 51-EE in a far-field region. The focusing lens 51-3 is configured to transform the second beam of light 51-5 into a third beam of light 51-6 aligned with a plurality of connection pads, for example, connection pads 233 of connector tab 231d and connection pads 213 of the circuit board 211 of FPC 210, of HSA 70. The third beam of light 51-6 has a substantially flat-top intensity profile 51-FF and a rectangular beam shape 51-CC matched to cover the plurality of connection pads. The third beam of light 51-6 is configured to generate heat about uniformly at the plurality of connection pads, for example, connection pads 233 of connector tab 231d and connection pads 213 of the circuit board 211 of FPC 210, to reflow solder of the connection pads in the laser-soldering operation.

Thus, in accordance with embodiments of the present invention, with further reference to FIGS. 7-10, the laser-beam device 51 and the support platform 53 of the laser-soldering tool 5 are configured to solder a plurality of connection pads 233 on a connector tab 231 of a lead-suspension 230 and a plurality of connection pads 213 on a projection 212 of a circuit board 211 of FPC 210. Alternatively, in accordance with other embodiments of the present invention, the laser-beam device 51 and the support platform 53 may also be configured to solder a plurality of head connection pads (not shown) of a lead-suspension 230 and a plurality of connection pads (not shown) on a head-slider 105. The wavelength of the light is selected to have negligible light absorption by a supporting layer on which the plurality of connection pads, for example, connection pads 233 and 213, is disposed. To about uniformly irradiate both pluralities of connection pads, for example, connection pads 233 and 213, disposed at about right angles to one another, a paraxial ray of the third beam of light 51-6, which is disposed in proximity to the optical axis 51-7 of the laser-beam device 51, is configured to have an angle of incidence 51-8 on the circuit board 211 of FPC 210 of about 45 degrees plus or minus 10 degrees.

With further reference to FIGS. 9-10, in accordance with other embodiments of the present invention, the laser soldering tool may include other component parts. For example, the laser-soldering tool 5 may be provided with the previously-described tail-spreader 6 configured to be inserted along a backside of a connector tab 231 of a lead-suspension 230 and configured to press the backside so as to press connection pads 233 on the connector tab 231 against an edge of a projection 212 of a circuit board 211 of FPC 210 in registry with connection pads 213 located in proximity to the edge on the projection 212 of the circuit board 211 of FPC 210. For another example, the laser-soldering tool 5 may further include a support-platform positioner configured to move at least one plurality of connection pads of the HSA 70 into alignment with the third beam of light 51-6 to reflow solder of the connection pads. By way of another example, the laser-soldering tool 5 may also include an adjustable lens holder coupled to the focusing lens 51-3, and configured to adjust a size of a rectangular shape of the third beam of light 51-6 at a focus point in proximity to a working area of the laser-soldering tool 5, where the plurality of connection pads of the HSA 70 may be disposed.

With further reference to FIG. 10, in yet another embodiment of the present invention, the laser-soldering tool 5 may also include a pulse forming system (not shown) configured to pulse the third beam of light 51-6 to control an amount of thermal energy to reflow the solder by limiting duration of a pulse of third beam of light 51-6. By way of example without limitation thereto, the pulse forming system may include a beam chopper, which is configured to unblank the light for the duration of the pulse of the third beam of light 51-6. Alternatively, by way of example without limitation thereto, the pulse forming system may include a time-modulatable laser power supply, which is configured to provide power to the laser 51-1 for essentially the duration of a pulse of the first beam of light 51-4, and correspondingly the third beam of light 51-6. Also, means for pulsing the light that may be disposed at other locations in the optical path are also within the spirit and scope of embodiments of the present invention that may be used to control the pulse duration of the various beams of light 51-4, 51-5 and 51-6. In accordance with embodiments of the present invention, the pulse may have a duration of between about 15 milliseconds (msec) to about 600 msec.

With further reference to FIGS. 7-10, in yet another embodiment of the present invention, the laser-soldering tool 5 may also include a second laser-beam device 52. Similar to the previously-described laser-beam device 51, the second laser-beam device 52 includes a second laser 52-1, a second RFTBS optic 52-2, and a second focusing lens 52-3. Thus, it is understood that embodiments of the present invention for the laser-beam device 51 discussed herein may also apply to the second laser-beam device 52. For example, the second laser 52-1 is configured to provide a fourth beam of light 52-4; and, the second RFTBS optic 52-2 is configured to shape the fourth beam of light 52-4 into a fifth beam of light 52-5 having a rectangular shape, similar to rectangular shape 51-BB, and a substantially flat-top intensity profile, similar to flat-top intensity profile 51-EE, in a far-field region. Similarly, the second focusing lens 52-3 is configured to transform the fifth beam of light 52-5 into a sixth beam of light 52-6 aligned with a second plurality of connection pads of the HSA 70. The sixth beam of light 52-6 has a substantially flat-top intensity profile, similar to flat-top intensity profile 51-FF, and a rectangular beam shape matched to cover the second plurality of connection pads, similar to connection pads 233 and 213, of HSA 70. Similar to the third beam of light 51-6 of the laser-beam device 51, the sixth beam of light 52-6 is also configured to generate heat about uniformly at the second plurality of connection pads to reflow solder of the second plurality of connection pads in a laser-soldering operation. Similar to the previously-described laser-beam device 51, a paraxial ray of the sixth beam of light 52-6, which is disposed in proximity to the optical axis 52-7 of the second laser-beam device 52, may also be configured to have an angle of incidence 52-8 on the circuit board 211 of FPC 210 of about 45 degrees plus or minus 10 degrees. The laser-beam device 51 and the second laser-beam device 52 are configured to about simultaneously reflow solder of the plurality of connection pads and solder of the second plurality of connection pads, respectively, in a single laser-soldering operation.

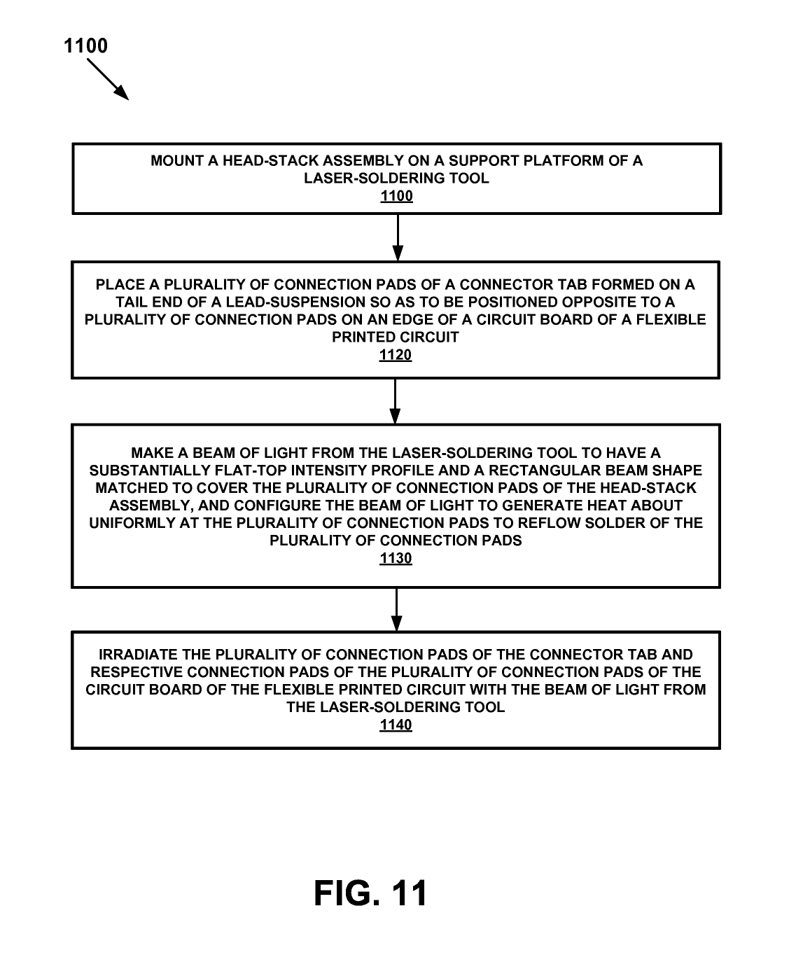

With reference now to FIG. 11, in accordance with an embodiment of the present invention, a flowchart 1100 is shown of a method for laser-soldering connection pads of a HSA for a HDD. Although not expressly stated in the following description, it is understood that embodiments of the present invention described above for the laser-beam device and the laser-soldering tool may be incorporated within the method for laser-soldering connection pads of the HSA for a HDD. The method includes at least the following operations. At 1110, mounting a HSA is mounted on a support platform of a laser-soldering tool. At 1120, a plurality of connection pads of a connector tab formed on a tail end of a lead-suspension is placed so as to be positioned opposite to a plurality of connection pads on an edge of a circuit board of a FPC. At 1130, a beam of light is made to have a substantially flat-top intensity profile and a rectangular beam shape matched to cover the plurality of connection pads of the HSA 70, and is configured to generate heat about uniformly at the plurality of connection pads to reflow solder of the plurality of connection pads. The beam of light described in the method may be, for example, the third beam of light of the laser-beam device and/or the sixth beam of light of the second laser-beam device, as previously described. At 1140, the plurality of connection pads of the connector tab and respective connection pads of the plurality of connection pads of the circuit board of the FPC are irradiated with the beam of light from the laser-soldering tool.

The method may also include sliding a tail-spreader along a backside of the connector tab. In addition, the method may include pulsing the beam of light to control an amount of thermal energy to reflow the solder by limiting duration of a pulse of the beam of light to between about 50 msec to about 200 msec. The method may also include laterally translating the support platform, on which the HSA is disposed, to align another plurality of connection pads of the HSA with the beam of light to reflow solder of the other plurality of connection pads. The method may also include rotating the support platform, on which the HSA is disposed, by about 180 degrees about an axis perpendicular to the base of the support platform; and, laterally translating the support platform, on which the HSA is disposed, to align the second plurality of connection pads of the HSA with the beam of light to reflow solder of the second plurality of connection pads.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A laser-beam device for laser-soldering connection pads of a head-stack assembly for a hard-disk drive, said laser-beam device comprising:
a laser configured to provide a first beam of light;
a rectangular flat-top beam-shaping optic configured to shape said first beam of light into a second beam of light having a rectangular shape, and a substantially flat-top intensity profile in a far-field region; and
a focusing lens configured to transform said second beam of light into a third beam of light aligned with a plurality of connection pads of said head-stack assembly;
wherein said third beam of light has a substantially flat-top intensity profile and a rectangular beam shape matched to cover said plurality of connection pads of said head-stack assembly, and is configured to generate heat about uniformly at said plurality of connection pads to reflow solder of said connection pads in a laser-soldering operation.

2. The laser-beam device of claim 1, wherein a wavelength of said light is selected to have negligible light absorption by a supporting layer on which said plurality of connection pads is disposed.

3. The laser-beam device of claim 2, wherein said wavelength of said light lies in a band extending from about green into and through near infra-red wavelengths.

4. The laser-beam device of claim 2, wherein said wavelength of said light lies in a band from about 1064 nanometers (nm) to about 1089 nm.

5. The laser-beam device of claim 1, wherein intensity of said second beam of light in a flat-top portion of said flat-top intensity profile varies by no more than plus or minus ten percent from an average intensity of said second beam of light in said flat-top portion of said flat-top intensity profile.

6. The laser-beam device of claim 1, further comprising:
a beam stop having an aperture dimensioned such that said beam stop is configured to cut off said second beam of light starting from a position proximate to a roll-off portion of said flat-top intensity profile and extending away from a flat-top portion of said flat-top intensity profile.

7. The laser-beam device of claim 6, wherein said aperture has a rectangular shape.

8. The laser-beam device of claim 1, further comprising:
a fiber-optical element coupling said laser to said rectangular flat-top beam-shaping optic, and configured to transmit said first beam of light from an exit pupil of said laser to an entrance pupil of said rectangular flat-top beam-shaping optic.

9. The laser-beam device of claim 1, wherein said laser comprises a continuous-wave laser.

10. The laser-beam device of claim 1, wherein said laser comprises a solid-state laser.

11. The laser-beam device of claim 1, wherein said laser comprises a pulsable laser.

12. The laser-beam device of claim 1, wherein said laser has a power of about 20 watts (W).

13. A laser-soldering tool for laser-soldering connection pads of a head-stack assembly for a hard-disk drive, said laser-soldering tool comprising:
a support platform configured to support said head-stack assembly; and
at least one laser-beam device comprising:
a laser configured to provide a first beam of light;
a rectangular flat-top beam-shaping optic configured to shape said first beam of light into a second beam of light having a rectangular shape, and a substantially flat-top intensity profile in a far-field region; and
a focusing lens configured to transform said second beam of light into a third beam of light aligned with a plurality of connection pads of said head-stack assembly;
wherein said third beam of light has a substantially flat-top intensity profile and a rectangular beam shape matched to cover said plurality of connection pads of said head-stack assembly, and is configured to generate heat about uniformly at said plurality of connection pads to reflow solder of said plurality of connection pads in a laser-soldering operation.

14. The laser-soldering tool of claim 13, wherein a wavelength of said light is selected to have negligible light absorption by a supporting layer on which said plurality of connection pads is disposed.

15. The laser-soldering tool of claim 13, wherein said laser-beam device and said support platform are configured to solder a plurality of connection pads on a connector tab of a lead-suspension to a plurality of connection pads on a projection of a circuit board of a flexible printed circuit.

16. The laser-soldering tool of claim 15, wherein a paraxial ray of said third beam of light is configured to have an angle of incidence on said circuit board of said flexible printed circuit of about 45 degrees plus or minus 10 degrees.

17. The laser-soldering tool of claim 13, wherein said laser-beam device and said support platform are configured to solder a plurality of head connection pads of a lead-suspension to a plurality of connection pads on a head-slider.

18. The laser-soldering tool of claim 13, further comprising:
a support-platform positioner configured to move at least one plurality of connection pads of said head-stack assembly into alignment with said third beam of light to reflow solder of said connection pads.

19. The laser-soldering tool of claim 13, further comprising:
a pulse forming system configured to pulse said third beam of light to control an amount of thermal energy to reflow said solder by limiting duration of a pulse of said third beam of light.

20. The laser-soldering tool of claim 13, further comprising:
a second laser-beam device comprising:
a second laser configured to provide a fourth beam of light;
a second rectangular flat-top beam-shaping optic configured to shape said fourth beam of light into a fifth beam of light having a rectangular shape, and a substantially flat-top intensity profile in a far-field region; and
a second focusing lens configured to transform said fifth beam of light into a sixth beam of light aligned with a second plurality of connection pads of said head-stack assembly;
wherein said sixth beam of light has a substantially flat-top intensity profile and a rectangular beam shape matched to cover said second plurality of connection pads of said head-stack assembly, and is configured to generate heat about uniformly at said second plurality of connection pads to reflow solder of said second plurality of connection pads in a laser-soldering operation.

21. The laser-soldering tool of claim 20, wherein said laser-beam device and said second laser-beam device are configured to about simultaneously reflow solder of said plurality of connection pads and solder of said second plurality of connection pads, respectively, in a single laser-soldering operation.

22. A method for laser-soldering connection pads of a head-stack assembly for a hard-disk drive, said method comprising:
mounting a head-stack assembly on a support platform of a laser-soldering tool;
placing a plurality of connection pads of a connector tab formed on an tail end of a lead-suspension so as to be positioned opposite to a plurality of connection pads on an edge of a circuit board of a flexible printed circuit;
irradiating said plurality of connection pads of said connector tab and respective connection pads of said plurality of connection pads of said circuit board of said flexible printed circuit with a beam of light from said laser-soldering tool;
wherein said beam of light has a substantially flat-top intensity profile and a rectangular beam shape matched to cover said plurality of connection pads of said head-stack assembly, and is configured to generate heat about uniformly at said plurality of connection pads to reflow solder of said plurality of connection pads.

23. The method of claim 22, further comprising:
pulsing said beam of light to control an amount of thermal energy to reflow said solder by limiting duration of a pulse of said beam of light to between about 15 milliseconds (msec) to about 600 msec.

24. The method of claim 22, further comprising:
laterally translating said support platform, on which said head-stack assembly is disposed, to align another plurality of connection pads of said head-stack assembly with said beam of light to reflow solder of said another plurality of connection pads.

25. The method of claim 22, further comprising:
rotating said support platform on which said head-stack assembly is disposed by about 180 degrees about an axis perpendicular to a base of said support platform; and
laterally translating said support platform, on which said head-stack assembly is disposed, to align a second plurality of connection pads of said head-stack assembly with said beam of light to reflow solder of said second plurality of connection pads.
